(19) United States
(12) Patent Application Publication
(10) Pub. No.: US 2019/0022956 A1
(43) Pub. Date: Jan. 24, 2019

(54) APPARATUS COMPRISING A PLURALITY OF JOINING DEVICES FOR PRODUCING SEMIFINISHED SHEETINGS AND PROCESS FOR PRODUCING THESE SEMIFINISHED SHEETINGS

(71) Applicant: Covestro AG, Leverkusen (DE)

(72) Inventor: Matthias Knaupp, Langenfeld (DE)

(21) Appl. No.: 16/070,460

(22) PCT Filed: Dec. 14, 2016
(86) PCT No.: PCT/EP2016/080924

§ 371 Date: Jul. 16, 2018

(30) Foreign Application Priority Data
Dec. 17, 2015 (EP) 15200643.3
Dec. 17, 2015 (EP) 15200659.9
Feb. 22, 2016 (EP) 16156688.0

(51) Int. Cl. B29C 70/20; B29C 70/54

(52) U.S. Cl. CPC B29C 70/20; B29K 2101/12; B29C 70/543; B29C 70/545

(57) ABSTRACT

The present disclosure provides a device and method for producing a semi-finished product web. The invention relates to a device comprising a plurality of connecting devices for the semi-continuous production of semi-finished product webs made from web subsections reinforced unidirectionally with continuous fibre, as well as to a method for producing such semi-finished product webs, wherein the fibres in the final semi-finished product webs are aligned at an angle x that does not equal 0° up to and including 90° to the longest axis of the final semi-finished product web in question.

The present invention relates to an apparatus comprising a plurality of joining devices for semicontinuous production of semifinished sheetings constructed from unidirectionally endless-fibre-reinforced sheeting sections and to a process for producing these semifinished sheetings, wherein the fibres in the final semifinished sheetings are aligned at an angle x having a magnitude from non-0° to 90° inclusive to the longest axis of the respective final semifinished sheetings.

A final semifinished sheeting is also referred to hereinbelow as “x°-tape”.

Tapes where the fibres in the semifinished sheeting are aligned at an angle x of 0° to the longest axis of the semifinished sheeting are referred to hereinbelow as “0°-tape” for short. One use of these 0°-tapes is as a precursor for the production of x°-tapes.

The term “tape” is used to mean both 0°-tapes and x°-tapes. The long sides of the tapes run parallel to one another.

In the context of the present invention semicontinuous production is to be understood as meaning a production process which comprises both process steps which proceed or are implemented continuously and process steps which proceed or are implemented discontinuously.

The x°-tape produced according to the invention on the apparatus according to the invention inter alia has the characteristic that the fibres are not disposed in a direction of 0° to the longest axis of the tape as in the case of 0°-tapes but rather are aligned at an angle x to the advancement direction, wherein the angle xis non-0°. The longest axis of a tape is also referred to as the running direction. “Endless-fibre-reinforced” is to be understood as meaning that the length of the reinforcing fibre is substantially equal to the dimension of the tape to be reinforced in the direction of the fibres. “Unidirectionally” in connection with “fibre” is to be understood as meaning that the fibres in the tape are aligned in only one direction.

The use of fibre-reinforced materials has steadily increased in the last decades on account of their outstanding specific properties. Fibre-reinforced materials are employed in structures subject to acceleration in particular, in order to allow weight reduction and thus minimize energy consumption without incurring a loss of strength or stiffness of the material.

A fibre-reinforced material, also known as fibre composite or composite for short, is an at least biphasic material consisting of a matrix material in which fibres are substantially completely embedded and encased. The matrix has a shape-conferring function, is intended to protect the fibres from external influences and is necessary to transfer forces between the fibres and to introduce external loads. The fibres make a decisive contribution to the mechanical performance of the material, with glass, carbon, polymer, basalt or natural fibres often being employed in industry. Depending on the intended use, matrix materials employed are generally thermosetting or thermoplastic polymers, occasionally even elastomers.

Thermosetting polymers are already long established in a great many industries. However, a decisive disadvantage is the lengthy curing time which leads to correspondingly lengthy cycle times during processing to afford components. This makes thermoset-based composites unattractive especially for high-volume industry applications. By contrast, thermoplastic-based composites, provided they are in the form of already fully-consolidated semifinished products, e.g. as endless-fibre-reinforced sheets or profiles, are often merely heated, formed and cooled when subjected to further processing, which may nowadays be achieved in cycle times of well under one minute. The processing may also be combined with further process steps, for example insert-moulding with thermoplastics, which makes it possible to achieve a very high degree of automation and integration of functions.

Reinforcing materials used are essentially semifinished textile products such as wovens, multi-ply laids or nonwovens (e.g. batts, random-laid fibre mats etc). It is a characteristic of these forms of fibre reinforcement that the orientation of the fibre—and thus the force paths in the subsequent component—is already determined in the semifinished textile product. While this does allow direct production of a multidirectionally reinforced composite it has disadvantages in terms of flexibility of ply construction, mechanical properties and economy. In thermoplastic-based systems these semifinished textile products are typically impregnated with polymer under the action of pressure and temperature and then cut to size and subjected to further processing as a cured sheet.

In addition to these already established systems based on semifinished textile products, thermoplastic-based tapes are becoming increasingly important. These offer economy advantages since the process step of semifinished textile product production may be eschewed. These thermoplastic-based tapes are suitable for producing multi-ply constructions, particularly also for producing multidirectional constructions.

A process and an apparatus for producing a unidirectionally endless-fibre-reinforced tape are described in EP 2 631 049 A1 for example, the disclosure of which is hereby fully incorporated into the description of the present invention by reference. As-yet-unpublished European patent application having filing number EP15200643.3, the disclosure of which is hereby likewise fully incorporated into the description of the present invention by reference, also describes a process and an apparatus for producing a unidirectionally endless-fibre-reinforced tape.

In the process disclosed in EP 2 631 049 A1, to produce an x°-tape, segments are separated from a supply sheeting having a main direction, a plastic matrix and a multiplicity of fibres fixed in a unidirectionally oriented manner and enclosing an angle of 0° to the running direction, these segments are arranged next to one another so that their longitudinal edges extending parallel to the running direction are parallel to one another and adjacent and enclose the predetermined angle to the longitudinal direction, and adjacent segments are then joined to one another in the region of their longitudinal edges. The supply sheeting thus corresponds to a 0°-tape. In the x°-tape the fibres are then arranged at an angle x non-0° to the running direction of the x°-tape.

The apparatus disclosed in EP 2 631 049 A1 comprises a dispensing arrangement for dispensing segments of the supply sheeting having a main direction, a plastic matrix and a multiplicity of fibres fixed in a unidirectionally oriented manner and enclosing an angle of 0° to the main direction, an aligning device for arranging the segments next to one another so that their longitudinal edges extending parallel to the main direction are parallel to one another and adjacent and enclose a predetermined angle (a) to the longitudinal direction, and a joining device for joining the adjacent segments in the region of their longitudinal edges.

The dispensing arrangement according to EP 2 631 049 A1—as is typical in machines for this purpose—is generally an advancement device for the supply sheeting from which the segments are cut and further transported to a joining device. The segments may also be supplied from a magazine or storage means. The joining device then joins the segments with one another to afford the x°-tape, preferably by adhesive-bonding or welding.

The disadvantage of this procedure is that both the adhesive-bonding and the welding take many times longer than the cutting and supplying of the segments. This has the result that the joining of the segments is the rate-determining step in the production of the x°-tape. The joining of the segments thus inhibits the rapid production of x°-tapes.

It is an object of the present invention to overcome the disadvantages of the prior art. It is a particular object of the present invention to provide an apparatus and a process which make it possible to accelerate the production of x°-tapes from elements cut and supplied from the supply sheeting.

The apparatus shall also be able to be arranged in a space-saving manner.

The apparatus according to the invention shall moreover make it possible to produce an x°-tape constructed from sheeting sections where the fibres exhibit an angle x having a magnitude from non-0° to 90° inclusive to the running direction of the x°-tape.

The object is achieved by the subject-matter of the independent claims. Advantageous embodiments are found in the dependent claims.

The object is in particular achieved by an apparatus comprising the following main components:
(A) a cutting device;
(B) a handling device;
(C₁; C₂; . . . Cₙ) at least two joining devices,
   wherein in the advancement direction the cutting device (A) is arranged upstream of the handling device (B), the handling device (B) is arranged upstream of the at least two joining devices (C₁; C₂; . . . Cₙ and the at least two joining devices (C₁; C₂; . . . Cₙ) are arranged in parallel with one another.

The index n denotes a positive integer not less than 3.

“Arranged in parallel with one another” is not to be understood as meaning that the at least two joining devices (C₁; C₂; . . . Cₙ) must be arranged spatially parallel to one another. In the context of the present invention “arranged in parallel with one another” is to be understood as meaning merely that the at least two joining devices (C₁; C₂; . . . Cₙ) are arranged relative to one another in such a way that they may be supplied with sheeting sections by the handling device (B) in the same way. However, the at least two joining devices (C₁; C₂; . . . Cₙ) may also be arranged spatially parallel to one another.

The following additional components are arranged upstream of the cutting device (A):
(D) an unwinding device;
(E) a first storage unit (accumulator)
(F) a feeding device.

The following additional components are arranged downstream of the respective joining apparatuses (C₁; C₂; . . . Cₙ):
(G) a take-off device
(H) a second storage unit (accumulator);
(J) a winding-up device.

The apparatus according to the invention preferably comprises precisely two or precisely three joining devices (C₁; C₂; C₃), particularly preferably precisely two joining devices (C₁; C₂).

Thus, for two joining devices, in the advancement direction, the following sequence of main and additional components results:

D-E-F-A-B-C₁(/C₂)-G₁(/G₂)-H₁ (/H₂)-J₁(/J₂).

For three joining devices, in the advancement direction, the following sequence of main and additional components results:

D-E-F-A-B-C₁(/C₂/C₃)-G₁(/G₂/G₃)-H₁(/H₂/H₃)-J₁ (/J₂/J₃).

The main and additional components form the overall apparatus.

Provided that reference is not being made to a particular joining device (C₁; C₂; . . . Cₙ) the joining device (C) without an index is used hereinbelow since the at least two joining devices do not differ in terms of their construction and their properties in respect of the invention. The same applies for the other reference numerals.

The unwinding device (D) may for example comprise a roll on which the 0°-tape is wound up. However, other implementations of the unwinding device (D) are also possible. The 0°-tape generally has a length of 100 to 3000 m, a width of 60 to 2100 mm, preferably of 500 to 1000 mm, particularly preferably of 600 to 800 mm, and a thickness of 100 to 350 μm, preferably of 120 to 200 μm in the running direction. However, a 0°-tape having other dimensions may also be processed on the apparatus according to the invention.

As already indicated, such 0°-tapes and the production thereof are known, for example from EP 2 631 049 A1. However, other unidirectionally endless-fibre-reinforced semifinished sheetings where the fibres are aligned at an angle of 0° to this semifinished sheeting in the running direction and long edges of the semifinished sheeting run parallel to one another may likewise be employed.

0°-tapes where the matrix material consists to an extent of at least 50 wt %, preferably at least 70 wt %, particularly preferably to an extent of at least 90 wt %, very particularly preferably at least 95 wt %, in particular to an extent of at least 97 wt %, of one or more thermoplastics are preferred. The thermoplastic is preferably selected from one or more of the series comprising polycarbonate, polyamide, polyethylene, polypropylene, polyphenylene sulfone, polyetherimide, a polyether ketone such as polyetheretherketone polyetherketoneketone, polyetheretheretherketone, polyetheretherketoneketone, poly(etherketone-etherketoneketone) and thermoplastic polyurethane. Thermoplastic polycarbonate is particularly preferred.

In the context of the present invention a “polycarbonate-based thermoplastic” is to be understood as meaning a thermoplastic comprising at least 50 wt %, preferably at least 60 wt %, preferably at least 70 wt %, in particular at least 80 wt %, particularly preferably at least 90 wt %, very particularly preferably at least 95 wt %, in particular at least 97 wt %, of polycarbonate. Expressed another way, in the context of the present invention a polycarbonate-based thermoplastic may comprise not more than 50 wt %, preferably not more than 40 wt %, preferably not more than 30 wt %, in particular not more than 20 wt %, particularly preferably not more than 10 wt %, very particularly preferably not more than 5 wt %, in particular not more than 3 wt %, of one or more constituents distinct from polycarbonate as blend partners.

It is preferable when the polycarbonate-based thermoplastic consists substantially, in particular to an extent of 100 wt %, of polycarbonate.

When reference is made here to polycarbonate this also comprehends mixtures of different polycarbonates. Polycarbonate is furthermore used here as an umbrella term and thus comprises both homopolycarbonates and copolycarbonates. The polycarbonates may further be linear or branched in known fashion.

It is preferable when the polycarbonate-based plastic consists to an extent of 70 wt %, 80 wt %, 90 wt % or substantially, in particular to an extent of 100 wt %, of a linear polycarbonate.

The polycarbonates may be produced in known fashion from diphenols, carbonic acid derivatives and optionally chain terminators and branching agents. Particulars pertaining to the production of polycarbonates have been well known to a person skilled in the art for at least about 40 years. Reference may be made here for example to Schnell, Chemistry and Physics of Polycarbonates, Polymer Reviews, Volume 9, Interscience Publishers, New York, London, Sydney 1964, to D. Freitag, U. Grigo, P. R. Müller, H. Nouvertné, BAYER AG, Polycarbonates in Encyclopedia of Polymer Science and Engineering, Volume 11, Second Edition, 1988, pages 648-718, and finally to U. Grigo, K. Kirchner and P. R. Müller Polycarbonate in BeckerBraun, Kunststoff-Handbuch, Volume 31, Polycarbonate, Polyacetale, Polyester, Celluloseester, Carl Hanser Verlag Munich, Vienna 1992, pages 117-299.

Aromatic polycarbonates are produced for example by reaction of diphenols with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Production via a melt polymerization process by reaction of diphenols with for example diphenyl carbonate is likewise possible. Diphenols suitable for producing polycarbonates are for example hydroquinone, resorcinol, dihydroxybiphenyls, bis(hydroxyphenyl)alkanes, bis(hydroxyphenyl)cycloalkanes, bis(hydroxyphenyl)sulphides, bis(hydroxyphenyl)ethers, bis(hydroxyphenyl)ketones, bis(hydroxyphenyl)sulphones, bis(hydroxyphenyl)sulphoxides, α,α′-bis(hydroxyphenyl)diisopropylbenzenes, phthalimidines derived from isatin derivatives or from phenolphthalein derivatives, and also the related ring-alkylated, ring-arylated and ring-halogenated compounds.

Preferably employed diphenols are those based on phthalimides, for example 2-aralkyl-3,3′-bis(4-hydroxyphenyl)phthalimides or 2-aryl-3,3′-bis(4-hydroxyphenyl)phthalimides such as 2-phenyl-3,3′-bis(4-hydroxyphenyl)phthalimide, 2-alkyl-3,3′-bis(4-hydroxyphenyl)phthalimides, such as 2-butyl-3,3′-bis(4-hydroxyphenyl), 2-propyl-3,3′-bis(4-hydroxyphenyl)phthalimides, 2-ethyl-3,3′-bis(4-hydroxyphenyl)phthalimides or 2-methyl-3,3′-bis(4-hydroxyphenyl)phthalimides and also diphenols based on isatins substituted at the nitrogen such as 3,3-bis(4-hydroxyphenyl)-1-phenyl-1H-indol-2-one or 2,2-bis(4-hydroxyphenyl)-1-phenyl-1H-indol-3-one.

Preferred diphenols are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulphone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane.

Particularly preferred diphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A.

These and other suitable diphenols are described for example in U.S. Pat. No. 3,028,635, U.S. Pat. No. 2,999,825, U.S. Pat. No. 3,148,172, U.S. Pat. No. 2,991,273, U.S. Pat. No. 3,271,367, U.S. Pat. No. 4,982,014 and U.S. Pat. No. 2,999,846, in DE-A 1 570 703, DE-A 2063 050, DE-A 2 036 052, DE-A 2 211 956 and DE-A 3 832 396, in FR-A 1 561 518, in the monograph H. Schnell, Chemistry and Physics of Polycarbonates, Interscience Publishers, New York 1964 and also in JP-A 620391986, JP-A 620401986 and JP-A 1055501986.

In the case of homopolycarbonates only one diphenol is employed and in the case of copolycarbonates two or more diphenols are employed.

Examples of suitable carbonic acid derivatives include phosgene or diphenyl carbonate. Suitable chain terminators that may be employed in the production of polycarbonates are monophenols. Suitable monophenols are for example phenol itself, alkylphenols such as cresols, p-tert-butylphenol, cumylphenol and mixtures thereof.

Preferred chain terminators are phenols which are mono- or polysubstituted with linear or branched, preferably unsubstituted C1 to C30 alkyl radicals or with tert-butyl. Particularly preferred chain terminators are phenol, cumylphenol and/or p-tert-butylphenol. The quantity of chain terminator to be used is preferably from 0.1 to 5 mol %, based on moles of diphenols respectively used. The addition of the chain terminators may be carried out before, during or after the reaction with a carboxylic acid derivative.

Suitable branching agents are the trifunctional or more than trifunctional compounds familiar in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4-dihydroxytriphenyl)methyl)benzene and 3,3-bis(3 -methyl-4-hydroxyphenyl)-2-oxo-2,3 -dihydroindole.

The amount of the branching agents for optional employment is preferably from 0.05 mol % to 3.00 mol % based on moles of diphenols used in each case. The branching agents can either be initially charged with the diphenols and the chain terminators in the aqueous alkaline phase or added dissolved in an organic solvent before the phosgenation. In the case of the transesterification process the branching agents are employed together with the diphenols.

Particularly preferred polycarbonates are the homopolycarbonate based on bisphenol A, the homopolycarbonate based on 1,3-bis(4-hydroxyphenyl)-3,3,5 -trimethylcyclohexane and the copolycarbonates based on the two monomers bisphenol A and 1,1-bis(4-hydroxyphenyl)-3,3,5-trimethylcyclohexane.

Furthermore, copolycarbonates may also be used. To produce these copolycarbonates 1 wt % to 25 wt %, preferably 2.5 wt % to 25 wt %, particularly preferably 2.5 wt % to 10 wt %, based on the total amount of diphenols to be employed, of polydiorganosiloxanes having hydroxyaryloxy end groups may be employed. These are known (U.S. Pat. No. 3,419,634, U.S. Pat. No. 3,189,662, EP 0 122 535, U.S. Pat. No. 5,227,449) and producible by literature processes. Likewise suitable are polydiorganosiloxane-containing copolycarbonates; the production of polydiorganosiloxane-containing copolycarbonates is described in DE-A 3 334 782 for example.

The polycarbonates may be present alone or as a mixture of polycarbonates. It is also possible to employ the polycarbonate or the mixture of polycarbonates together with one or more plastics distinct from polycarbonate as blend partners.

Blend partners that may be employed include polyamides, polyesters, in particular polybutylene terephthalate and polyethylene terephthalate, polylactide, polyether, thermoplastic polyurethane, polyacetal, fluoropolymer, in particular polyvinylidene fluoride, polyethersulphones, polyolefin, in particular polyethylene and polypropylene, polyimide, polyacrylate, in particular poly(methyl)methacrylate, polyphenylene oxide, polyphenylene sulphide, polyetherketone, polyaryletherketone, styrene polymers, in particular polystyrene, styrene copolymers, in particular styrene acrylonitrile copolymer, acrylonitrile butadiene styrene block copolymers and polyvinyl chloride.

Up to 50.0 wt %, preferably 0.2 to 40 wt %, particularly preferably 0.10 to 30.0 wt %, based on the weight of the thermoplastic, of other customary additives may optionally also be present.

This group comprises flame retardants, anti-drip agents, thermal stabilizers, demoulding agents, antioxidants, UV absorbers, IR absorbers, antistats, optical brighteners, light-scattering agents, colourants such as pigments, including inorganic pigments, carbon black and/or dyes, and inorganic fillers in amounts customary for polycarbonate. These additives may be added individually or else in a mixture.

Such additives as are typically added in the case of polycarbonates are described, for example, in EP-A 0 839 623, WO-A 96/15102, EP-A 0 500 496 or “Plastics Additives Handbook”, Hans Zweifel, 5th Edition 2000, Hanser Verlag, Munich.

Polyamides suitable in accordance with the invention are likewise known or producible by literature processes.

Polyamides suitable in accordance with the invention are known homopolyamides, copolyamides and mixtures of these polyamides. These may be semicrystalline and/or amorphous polyamides. Suitable semicrystalline polyamides include polyamide-6, polyamide-6,6 and mixtures and corresponding copolymers of these components. Also contemplated are semicrystalline polyamides whose acid component consists entirely or partly of terephthalic acid and/or isophthalic acid and/or suberic acid and/or sebacic acid and/or azelaic acid and/or adipic acid and/or cyclohexane dicarboxylic acid, whose diamine component consists entirely or partly of m- and/or p-xylylenediamine and/or hexamethylenediamine and/or 2,2,4-trimethylhexamethylenediamine and/or 2,4,4-trimethylhexamethylenediamine and/or isophoronediamine and whose composition is known in principle.

Mention may also be made of polyamides produced entirely or partly from lactams having 7 to 12 carbon atoms in the ring, optionally with co-use of one or more of the abovementioned starting components.

Particularly preferred semicrystalline polyamides are polyamide-6 and polyamide-6,6 and mixtures thereof Amorphous polyamides that may be employed include known products. These are obtained by polycondensation of diamines such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,5,5 -trimethylcyclohexylamine, 2,5- and/or 2,6-bis(aminomethyl)norbornane and/or 1,4-diaminomethylcyclohexane with dicarboxylic acids such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers obtained by polycondensation of two or more monomers as are copolymers produced by addition of aminocarboxylic acids such as e-aminocaproic acid, w-aminoundecanoic acid or w-aminolauric acid or lactams thereof.

Particularly suitable amorphous polyamides are polyamides produced from isophthalic acid, hexamethylenediamine and further diamines such as 4,4-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and ϵ-caprolactam; or from isophthalic acid, 3,3′-dimethyl-4,4′-diaminodicyclohexylmethane and laurolactam; or from terephthalic acid and the isomer mixture composed of 2,2,4- and/or 2,4,4-trimethylhexamethylenediamine.

Instead of pure 4,4′-diaminodicyclohexylmethane it is also possible to employ mixtures of the geometrically isomeric diaminodicyclohexylmethanes composed of
70 to 99 mol % of the 4,4′-diamino isomer,
1 to 30 mol % of the 2,4′-diamino isomer and
0 to 2 mol % of the 2,2′-diamino isomer,
   optionally correspondingly more-highly condensed diamines obtained by hydrogenation of technical-grade diaminodiphenylmethane. Up to 30% of the isophthalic acid may be replaced by terephthalic acid.

The polyamides preferably have a relative viscosity (measured using a 1 wt % solution in m-cresol at 25° C.) of 2.0 to 5.0, particularly preferably of 2.5 to 4.0.

Thermoplastic polyurethanes suitable in accordance with the invention are likewise known or producible by literature processes.

An overview of the production, properties and applications of thermoplastic polyurethanes (TPUs) may be found for example in Kunststoff Handbuch [G. Becker, D. Braun], volume 7 “Polyurethane”, Munich, Vienna, Carl Hanser Verlag, 1983.

TPUs are usually constructed from linear polyols (macrodiols), such as polyester, polyether or polycarbonate diols, organic diisocyanates and short-chain, mostly difunctional alcohols (chain extenders). The TPUs may be produced in continuous or batchwise fashion. The best-known production processes are the belt process (GB-A 1 057 018) and the extruder process (DE-A 19 64 834).

The employed thermoplastic polyurethanes are reaction products of
I) organic diisocyanates
II) polyols
III) chain extenders.

Diisocyanates (I) that may be used include aromatic, aliphatic, araliphatic, heterocyclic and cycloaliphatic diisocyanates or mixtures of these diisocyanates (cf HOUBEN-WEYL “Methoden der organischen Chemie”, Volume E20 “Makromolekulare Stoffe”, Georg Thieme Verlag, Stuttgart, New York 1987, pp. 1587-1593 or Justus Liebigs Annalen der Chemie, 562, pages 75 to 136).

Specifically, mention may be made for example of: aliphatic diisocyanates, such as hexamethylene diisocyanate, cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-dicyclohexylmethane diisocyanate and also the corresponding isomer mixtures, aromatic diisocyanates, such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanato-1,2-diphenylethane and 1,5-naphthylene diisocyanate. Preference is given to using 1,6-hexamethylene diisocyanate, isophorone diisocyanate, dicyclohexylmethane diisocyanate, diphenylmethane diisocyanate isomer mixtures having a 4,4′-diphenylmethane diisocyanate content of >96 wt % and in particular 4,4′-diphenylmethane diisocyanate and 1,5-naphthylene diisocyanate. The recited diisocyanates may be used individually or in the form of mixtures with one another. They may also be used together with up to 15 wt % (based on the total amount of diisocyanate) of a polyisocyanate, for example triphenylmethane 4,4′,4″-triisocyanate or polyphenylpolymethylene polyisocyanates.

Zerewitinoff-active polyols (II) are those having on average not less than 1.8 to not more than 3.0 Zerewitinoff-active hydrogen atoms and a number-average molecular weight M̅ₙ of 500 to 10 000 g/mol, preferably 500 to 6000 g/mol.

This includes, in addition to compounds comprising amino groups, thiol groups or carboxyl groups, in particular compounds comprising two to three, preferably two, hydroxyl groups, specifically those having number-average molecular weights M̅ₙ of 500 to 10 000 g/mol, particularly preferably those having a number-average molecular weight M̅ₙ of 500 to 6000 g/mol, for example hydroxyl-containing polyesters, polyethers, polycarbonates and polyesteramides or mixtures thereof.

Suitable polyether diols may be produced by reacting one or more alkylene oxides having 2 to 4 carbon atoms in the alkylene radical with a starter molecule comprising two active hydrogen atoms in bonded form. Alkylene oxides that may be mentioned are for example: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides may be used individually, in alternating succession or as mixtures. Contemplated starter molecules include for example: water, amino alcohols, such as N-alkyldiethanolamines, for example N-methyldiethanolamine, and diols such as ethylene glycol, 1,3-propylene glycol, 1,4-butanediol and 1,6-hexanediol. Mixtures of starter molecules may optionally also be employed. Suitable polyetherols further include the hydroxyl-containing polymerization products of tetrahydrofuran. Trifunctional polyethers may also be employed in proportions of 0 to 30 wt % based on the bifunctional polyethers but at most in an amount that provides a product that is still thermoplastically processable. The essentially linear polyether diols preferably have number-average molecular weights M of 500 to 10 000 g/mol, particularly preferably 500 to 6000 g/mol. They may be used either individually or in the form of mixtures with one another.

Suitable polyester diols may be produced from, for example, dicarboxylic acids having 2 to 12 carbon atoms, preferably 4 to 6 carbon atoms, and polyhydric alcohols. Contemplated dicarboxylic acids include for example: aliphatic dicarboxylic acids such as succinic acid, glutaric acid, adipic acid, suberic acid, azelaic acid and sebacic acid, or aromatic dicarboxylic acids, such as phthalic acid, isophthalic acid and terephthalic acid. The dicarboxylic acids can be used individually or as mixtures, for example in the form of a succinic acid, glutaric acid and adipic acid mixture. To produce the polyester diols, it may in some cases be advantageous to use instead of the dicarboxylic acids the corresponding dicarboxylic acid derivatives, such as carboxylic diesters having 1 to 4 carbon atoms in the alcohol radical, carboxylic anhydrides or carbonyl chlorides. Examples of polyhydric alcohols are glycols having 2 to 10, preferably 2 to 6, carbon atoms, for example ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending on the desired properties, the polyhydric alcohols may be used alone or in admixture with one another. Also suitable are esters of carbonic acid with the recited diols, in particular those having 4 to 6 carbon atoms, such as 1,4-butanediol or 1,6-hexane diol, condensation products of ω-hydroxycarboxylic acids such as ω-hydroxycaproic acid or polymerization products of lactones, for example optionally substituted ω-caprolactones. Preferably employed polyester diols are ethanediol polyadipate, 1,4-butanediol polyadipate, ethanediol-1,4-butanediol polyadipate, 1,6-hexanediol neopentyl glycol polyadipate, 1,6-hexanediol-1,4-butanediol polyadipate and polycaprolactone. The polyester diols have number-average molecular weights M̅ₙ of 500 to 10 000 g/mol, particularly preferably 600 to 6000 g/mol, and may be used individually or in the form of mixtures with one another.

Zerewitinoff-active polyols (III) are so-called chain extending agents and have on average 1.8 to 3.0 Zerewitinoff-active hydrogen atoms and have a number-average molecular weight M̅ₙ of 60 to 500 g/mol. This is to be understood as meaning not only amino-, thiol- or carboxyl-containing compounds but also compounds having two to three, preferably two, hydroxyl groups.

Chain extending agents employed are diols or diamines having a molecular weight of 60 to 495 g/mol, preferably aliphatic diols having 2 to 14 carbon atoms, for example ethanediol, 1,2-propanediol, 1,3-propanediol, 1,4-butanediol, 2,3-butanediol, 1,5-pentanediol, 1,6-hexanediol, diethylene glycol and dipropylene glycol. Also suitable, however, are diesters of terephthalic acid with glycols having 2 to 4 carbon atoms, for example terephthalic acid bis-ethylene glycol or terephthalic acid bis-1,4-butanediol, hydroxyalkylene ethers of hydroquinone, for example 1,4-di(β-hydroxyethyl)hydroquinone, ethoxylated bisphenols, for example 1,4-di(β-hydroxyethyl)bisphenol A, (cyclo)aliphatic diamines, such as isophoronediamine, ethylenediamine, 1,2-propylenediamine, 1,3-propylenediamine, N-methylpropylene-1,3-diamine, N,N′-dimethylethylenediamine and aromatic diamines such as 2,4-tolylenediamine, 2,6-tolylenediamine, 3,5-diethyl-2,4-tolylenediamine or 3,5-diethyl-2,6-tolylenediamine or primary mono-, di-, tri- or tetraalkyl-substituted 4,4′-diaminodiphenylmethanes. Particularly preferably employed chain extenders are ethanediol, 1,4-butanediol, 1,6-hexanediol, 1,4-di(β-hydroxyethyl)hydroquinone or 1,4-di(β-hydroxyethyl)bisphenol A. Mixtures of the above mentioned chain extenders may also be employed. In addition, relatively small amounts of triols may also be added.

Compounds that are monofunctional toward isocyanates may be employed in proportions of up to 2 wt % based on thermoplastic polyurethane, as so-called chain terminators or demoulding aids.

Examples of suitable compounds are monoamines such as butyl- and dibutylamine, octylamine, stearylamine, N-methylstearylamine, pyrrolidine, piperidine or cyclohexylamine, monoalcohols such as butanol, 2-ethylhexanol, octanol, dodecanol, stearyl alcohol, the various amyl alcohols, cyclohexanol and ethylene glycol monomethyl ether.

The relative amounts of the compounds (II) and (III) are preferably chosen such that the ratio of the sum of the isocyanate groups in (I) to the sum of the Zerewittinoff-active hydrogen atoms in (II) and (III) is 0.85:1 to 1.2:1, preferably 0.95:1 to 1.1:1.

The thermoplastic polyurethane elastomers (TPUs) employed in accordance with the invention may comprise as auxiliary and additive substances up to a maximum of 20 wt % based on the total amount of TPU of the customary auxiliary and additive substances. Typical auxiliary and additive substances are catalysts, pigments, colourants, flame retardants, stabilizers against ageing and weathering effects, plasticizers, glidants and demoulding agents, fungistatic and bacteriostatic substances and fillers and mixtures thereof.

Suitable catalysts are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and similar and also in particular organic metal compounds such as titanic esters, iron compounds or tin compounds such as tin diacetate, tin dioctoate, tin dilaurate or the dialkyltin salts of aliphatic carboxylic acids such as dibutyltin diacetate or dibutyltin dilaurate or similar. Preferred catalysts are organic metal compounds, in particular titanic esters, iron compounds and tin compounds. The total amount of catalysts in the TPUs is generally about 0 to 5 wt %, preferably 0 to 2 wt %, based on the total amount of TPU.

Examples of further additive substances are glidants, such as fatty acid esters, metal soaps thereof, fatty acid amides, fatty acid ester amides and silicone compounds, antiblocking agents, inhibitors, stabilizers against hydrolysis, light, heat and discolouration, flame retardants, dyes, pigments, inorganic and/or organic fillers and reinforcers. Reinforcers are in particular fibrous reinforcing materials, for example inorganic fibres, which are produced by prior art methods and may also be sized. Further information about the recited auxiliary and additive substances may be found in the specialist literature, for example in the monograph by J. H. Saunders and K. C. Frisch “High Polymers”, Volume XVI, Polyurethane, Part 1 and 2, Interscience Publishers 1962/1964, in “Taschenbuch für Kunststoff-Additive” by R. Gächter and H. Müller (Hanser Verlag Munich 1990) or in DE-A 29 01 774.

Further additions which may be incorporated into the TPU are thermoplastics, for example polycarbonates and acrylonitrile/butadiene/styrene terpolymers, in particular ABS. Other elastomers such as rubber, ethylene/vinyl acetate copolymers, styrene/butadiene copolymers and other TPUs may also be used.

Also suitable for incorporation are commercially available plasticizers such as phosphates, phthalates, adipates, sebacates and alkylsulphonic esters.

Polyethylene suitable in accordance with the invention is likewise known or producible by literature processes. The polyethylene may be not only PE-HD (HDPE), PE-LD (LDPE), PE-LLD (LLDPE), PE-HMW but also PE-UHMW.

The polypropylene, polyphenylene sulphone, polyetherimide and polyether ketone suitable in accordance with the invention is likewise known or producible by literature processes.

It may generally be useful to add thermal stabilizers and flow improvers to the thermoplastic used for the matrix provided that these do not reduce the molecular weight of the thermoplastic and/or reduce the Vicat temperature.

Contemplated materials for the fibres include both natural fibres, for example fibrous minerals or vegetable fibres, and man-made fibres, for example inorganic synthetic fibres or organic synthetic fibres. Glass, carbon or polymer fibres are preferred, glass or carbon fibres being preferred in turn.

It is very particularly preferable to employ glass fibres having a modulus of elasticity of greater than 70 GPa, preferably greater than 80 GPa, particularly preferably greater than 90 GPa, or carbon fibres having a modulus of elasticity of greater than 240 GPa, preferably greater than 245 GPa, particularly preferably of 250 GPa or more. Carbon fibres having these aforementioned moduli of elasticity are preferred in particular. Such carbon fibres are for example commercially available from Mitsubishi Rayon CO., LtD. under the trade name Pyrofil.

The fibres are generally coated with a so-called size. When a thermoplastic is used as the matrix material, suitable systems for sizes often comprise a thermoset, a silane, an epoxy resin or a polyurethane. However it is also possible for the fibres, or a portion of the fibres, to comprise no size.

From this unwinding device (D) the 0°-tape is continuously unwound and fed in the advancement direction to the storage device. The first storage unit (E) then feeds the 0°-tape via the feeding device (F) to the cutting device (A). The first storage unit (E) may for example comprise a plurality of rolls mounted such that they are translationally movable in the direction of gravity or which may be configured in another useful fashion. The feeding device (F) may for example be implemented in the form of an unrolling device, conveyor belt or a conveyor roller sector. The feeding device (F) feeds the 0°-tape such that the running direction of the 0°-tape and the advancement direction of the apparatus according to the invention coincide.

The cutting of the 0°-tape is a discontinuous operation. The continuous advancement of the 0°-tape is therefore interrupted at certain intervals in order to be able to perform the cutting operation such that the cut corresponds to a straight line having the angle x to the running direction of the 0°-tape. The cutting device (A) may for example be in the form of a rotary cutter, an impact shear, a plate shear, a guillotine, a lever shear, a laser, a waterjet cutting device, a milling machine, a chopsaw, a band saw, a cutting disc or another suitable embodiment. The cutting device (A) is used to cut sheeting sections from the 0°-tape at a predetermined angle x to the advancement direction of the 0°-tape, wherein the advancement direction is assigned the angle 0°. The magnitude of the angle x is from greater than 0° to 90° inclusive, wherein the angle x preferably has a magnitude of 30°, 33°, 45°, 60°, 75° or 90°; the angle x particularly preferably has a magnitude of 90°. When the angle x is determined clockwise to the advancement direction then the value of the angle x is prefixed with a minus and when the angle x is determined anticlockwise then the value of the angle x is prefixed with a plus which, however, is not shown in line with general convention. The magnitude of the angle x is determined such that it is defined by a smallest possible magnitude. Thus an angle x having a value of 135° would be equal to an angle x having a value of −45° ; the magnitude of the angle x of 45° is then reported; an angle x having a value of 120° would be equal to an angle x having a value of −60° ; the magnitude of the angle x of 60° is then reported.

The cutting device is preferably configured such that it can be used to set any desired angles between 0° and 90° both clockwise and anticlockwise.

The change from continuous to discontinuous advancement is performed by the feeding device (F), wherein the first storage unit (E) during interruption of the advancement of the 0°-tape intermediately stores the 0°-tape continuously fed from the unwinding device (D).

The sheeting sections cut from the 0°-tape are each alternatingly transported from the handling device (B) to one of the at least two joining devices (C₁; C₂; . . . Cₙ) in a further discontinuous step. In this connection alternatingly is to be understood as meaning that the handling device (B) does not supply a particular joining device (C) of the at least two joining devices (C₁; C₂; . . . Cₙ) with a sheeting section in immediate succession but rather first transports a sheeting section to another joining device (C) of the joining devices (C₁; C₂; . . . Cₙ). It is preferable when the handling device (B) supplies the at least two joining devices (C₁; C₂; . . . Cₙ) in an order such that all of the at least two joining devices (C₁; C₂; . . . Cₙ) are always supplied with sheeting sections at the same point in time in the sequence of the at least two joining devices (C₁; C₂; . . . Cₙ) and it is particularly preferable when all of the at least two joining devices (C₁; C₂; . . . Cₙ) are supplied with sheeting sections at identical time intervals.

According to the invention it is possible for example for cutting device (A), handling device (B) and two joining devices (C₁) and (C₂) to be arranged in the shape of a Y, wherein the cutting device (A) would be arranged at the foot of the Latin capital letter Y, the handling device (B) at the branching point and the two joining devices (C₁) and (C₂) at the upper ends of the Y. For the sake of simplicity this arrangement is also referred to as the Y arrangement. In the Y arrangement the handling device (B) may for example transport a sheeting piece to the joining device (C₁), then to the joining device (C₂) and then to the joining device (C₁) again etc.

According to the invention it is also possible for example for cutting device (A), handling device (B) and three joining devices (C₁), (C₂) and (C₃) to be arranged in the shape of the Greek capital letter ψ (Psi), wherein the cutting device (A) would be arranged at the foot of the ψ, the handling device (B) at the branching point and the three joining devices (C₁), (C₂) and (C₃) at the upper ends of the Ψ. For the sake of simplicity this arrangement is also referred to as the Psi arrangement. In the Psi arrangement the handling device (B) may for example transport a sheeting piece to the joining device (C₁), then to the joining device (C₂), then to the joining device (C₃) and then to the joining device (C₁) again etc.

According to the invention it is also possible for example for cutting device (A), handling device (B) and two joining devices (C₁) and (C2) to be arranged in the shape of the Latin capital letter E, wherein the cutting device (A) would be arranged at the free end of the middle leg of the E, the handling device (B) at the branching point in the middle and the two joining devices (C₁) and (C₂) at the free upper and lower outer ends of the E. For the sake of simplicity this arrangement is also referred to as the E arrangement. In the E arrangement the handling device (B) may for example transport a sheeting piece to the joining device (C₁) and then to the joining device (C₂), and then to the joining device (C₁) again etc.

According to the invention it is also possible for example for cutting device (A), handling device (B) and three joining devices (C₁), (C₂) and (C₃) to be arranged in the shape of the Latin capital letter K, wherein the cutting device (A) would be arranged at the left-hand lower foot of the K, the handling device (B) at the branching point and the three joining devices (C₁), (C₂) and (C₃) at the other ends of the K. For the sake of simplicity this arrangement is also referred to as the K arrangement. In the K arrangement the handling device (B) may for example transport a sheeting piece to the joining device (C₁), then to the joining device (C₂), then to the joining device (C₃) and then to the joining device (C₁) again etc.

As a development of the K arrangement it is also possible in accordance with the invention for example for cutting device (A), handling device (B) and three joining devices (C₁), (C₂) and (C₃) to be arranged in the shape of the Latin capital letter X, wherein the cutting device (A) would be arranged at any desired foot of the X, the handling device (B) at the branching point and the three joining devices (C₁), (C₂) and (C₃) at the other ends of the X. The angles at which the cutting device (A) and the three joining devices (C₁), (C₂) and (C₃) branch off from the handling device (B) are—taking into account spatial relationships—freely choosable. For the sake of simplicity this arrangement is also referred to as the X arrangement. In the X arrangement the handling device (B) may for example transport a sheeting piece to the joining device (C₁), then to the joining device (C₂), then to the joining device (C₃) and then to the joining device (C₁) again etc.

As a development of the X arrangement it is also possible in accordance with the invention for example for cutting device (A), handling device (B) and four or more joining devices (C₁; C₂; . . . Cₙ) to be arranged in a star shape, wherein the cutting device (A) would be arranged at the tip of any desired point of the star, the handling device (B) at the branching point and the four or more joining devices (C₁; C₂; . . . Cₙ) at the other point tips of the star. The angles at which the cutting device (A) and the four or more joining devices (C₁; C₂; . . . Cₙ) branch off from the handling device (B) are—taking into account spatial relationships—freely choosable. For the sake of simplicity this arrangement is also referred to as the star arrangement. In the star arrangement the handling device (B) may for example transport a sheeting piece to the joining device (C1), then to the joining device (C2), then to the joining device (C3) etc. until the joining device Cₙ has been supplied and then to the joining device (C₁) again etc.

It will be appreciated that other arrangements of cutting device (A), handling device (B) and at least two joining devices (C₁, C₂, . . . Cₙ) with respect to one another are also possible.

Which of the above exemplarily mentioned shapes, or else other shape according to the invention, the cutting device (A), handling device (B) and at least two joining devices (C₁, C₂, . . . Cₙ) are best arranged in relative to one another is determined for example by the space available for the overall apparatus or by the number of joining devices (C₁, C₂, . . . Cₙ) which shall or can be assigned to a cutting device (A) and handling device (B). The latter is especially dependent on the duration of step (1) of cutting the 0°-tape compared to step (2) of alternatingly distributing the sheeting sections among the at least two joining devices (C₁; C₂; . . . Cₙ) and in particular compared to step (3) of cohesively joining the sheeting sections to afford x°-tapes. Of the three recited steps, step (3) of cohesively joining the sheeting sections to afford x°-tapes is the slowest by some margin; it has a duration of about 8 to 9 seconds when joining is by ultrasound for example. Step (1) of cutting the 0°-tape is the second fastest; it has a duration of about 4 seconds when a rotary cutter is employed for example. Step (2) is the fastest of the three recited steps and has a duration of only about 3 seconds or less when a suitable handling device (B), for example a robot arm in combination with a crossbeam, is used. Accordingly, the handling device (B) can dispatch and supply the sheeting sections faster than the cutting device (A) can produce, and a single joining device (C₁) can further process, the sheeting sections. Therefore—figuratively speaking—“congestion” of sheeting sections occurs not upstream of the handling device (B) but downstream of the handling device (B). When step (1) is implemented twice as fast as step (3) as exemplarily indicated above it is advantageous according to the invention to assign two joining devices C₁ and C₂ to a cutting device (A). When step (1) is implemented three times as fast as step (3) as is also possible for example it is advantageous according to the invention to assign three joining devices C₁, C₂ and C₃ to a cutting device (A). It is thus advantageous according to the invention to assign to the cutting device (A) a number of joining devices (C₁, C₂, . . . Cₙ) equal to the quotient of the implementation speed of step (3) divided by the implementation speed of step (1). If this quotient is a non-integer a person skilled in the art will decide based on the other technical and economic circumstances whether to round this number up to the next highest integer or down to the next lowest integer. He will take into account, for example, whether it is more sensible to slow down step (1), which could be necessary in case of a rounding-down, or whether he is willing to accept the occurrence of further delays in step (3) which would be the case for a rounding-up.

The E-arrangement is preferred in accordance with the invention.

As is readily apparent from the various shapes of the arrangement of cutting device (A), handling device (B) and at least two joining devices (C₁; C₂; . . . Cₙ), the advancement direction of at least some of the sheeting sections is altered by the handling device (B) during passage to the at least two joining devices (C₁; C₂; . . . Cₙ) since for space reasons at least one of the at least two joining devices cannot be aligned with the cutting device (A) and the additional components arranged upstream thereof. It is also possible according to the invention for none of the at least two joining devices (C₁; C₂; . . . Cₙ) to be aligned with the cutting device (A) and the additional components arranged upstream thereof. It is thus also possible but not mandatory according to the invention for one of the at least two joining devices (C₁; C₂; . . . Cₙ) to be aligned with the cutting device (A) and the additional components arranged upstream thereof. This may be the case for example in the K, Psi or X arrangement.

The sheeting pieces are rotated and laid one behind the other in the new or unchanged advancement direction in the same plane in such a way that in the sheeting sections the sides which in the 0°-tape were regions of the mutually parallel outsides are now disposed opposite one another. The regions which in the 0°-tape were disposed within said tape now form the mutually parallel outsides.

It must be ensured that the handling device (B) rotates the sheeting sections in the new or unchanged advancement direction in such a way that after the rotation the regions which in the 0°-tape were disposed within said tape are now disposed parallel to the running direction of the respective x°-tape while the sides which in the 0°-tape were regions of the mutually parallel outsides are now aligned at the magnitude of the angle x to the running direction of the respective x°-tape.

The handling device (B) may be configured for example as a robot gripping arm or gripping hand, a turntable, a rotatable suction device or in another suitable fashion. In the case of the E arrangement preferred in accordance with the invention the handling device (B) may be combined with a crossbeam (K) by means of which the handling device (B) supplies the sheeting sections cut from the x°-tape to the two joining devices C₁ and C₂. In the case of the Psi arrangement too the handling device may be combined with a crossbeam (K) by means of which in this case the handling device (B) supplies the sheeting sections cut from the x°-tape to the three joining devices C₁, C₂ and C₃.

The handling device (B) is followed by the at least two joining devices (C₁; C₂; . . . Cₙ). In said joining devices (C) in a further discontinuous step the sheeting sections are cohesively joined to one another to form the x°-tape such that the sides that in the 0°-tape were regions of the mutually parallel outsides are now disposed within the x°-tape and the mutually parallel outsides of the x°-tape are formed by regions which in the 0°-tape were disposed within said tape. In the x°-tape the fibres accordingly also have an alignment having the magnitude of the angle x to the running direction of the respective x°-tape.

The at least two joining devices (C₁; C₂; . . . Cₙ) may be configured as welding devices or adhesive-bonding devices. Said devices are preferably configured as welding devices, wherein the welding operation is performed for example by means of hot bars, laser, hot air, infrared radiation or ultrasound, wherein performing the welding operation by means of ultrasound is preferred. The welding operation is particularly preferably performed as in unpublished European patent application EP15200659.9, the disclosure of which is hereby fully incorporated into the description of the present invention by reference. In accordance with the invention this join is implemented as an end-to-end join so that there is no overlap of the sheeting sections, i.e. the sheeting sections are joined to one another only at the faces which in the 0°-tape were regions of the mutually parallel outsides, regions of the top or bottom side of the 0°-tape are not involved in the production of the join.

It is preferable in accordance with the invention when the at least two joining devices (C₁; C₂; . . . Cₙ) are implemented in the same way, i.e. all as welding apparatuses or all as adhesive-bonding apparatuses. However, it is also possible to implement the at least two joining devices (C₁; C₂; . . . Cₙ) differently.

The at least two joining devices (C₁; C₂; . . . Cₙ) are each followed in the respective advancement directions by a take-off device (G) that effects further transportation of the x°-tape. On account of the discontinuous operation of the at least two joining devices (C₁; C₂; . . . Cₙ) and the discontinuous growth in length of the x°-tape arising therefrom this further transportation is initially likewise discontinuous. The respective take-off device (G) is then followed by a second storage unit (H) which converts the discontinuous advancement into a continuous advancement. This in each case second storage unit (H) may be configured in an identical or different manner than the first storage unit (E) which is located upstream of the cutting device. Each storage unit is followed by a respective winding-up device (J) which winds the x°-tape onto a core.

The apparatus according to the invention makes it possible to accelerate the production of x°-tapes from elements cut and supplied from the supply sheeting compared to apparatuses having only one joining device.

It is also possible through suitable choice of the arrangement to arrange the apparatus in a space-saving manner. Thus, the Psi arrangement for example may be arranged in a particularly space-saving manner when the available area in one direction extends at least twice as far as in the other direction that is perpendicular to the first direction. By contrast, the E arrangement for example may be arranged in a particularly space-saving manner when the available area in one direction extends less than twice as far as in the other direction that is perpendicular to the first direction.

This has the result that compared to arrangements from the prior art less room is required and a plurality of apparatuses according to the invention may be more easily accommodated in a machine hall for example.

The apparatus according to the invention moreover makes it possible to produce an x°-tape constructed from sheeting sections where the fibres exhibit an angle x having a magnitude from non-0° to 90° inclusive to the running direction of the x°-tape.

The present invention also provides a process for producing x°-tapes in which the fibres are aligned at an angle x having a magnitude from non-0° to 90° inclusive to the running direction of the respective x°-tape. The process according to the invention is preferably performed on the abovedescribed apparatus according to the invention.

Said process comprises the steps of:

0 (1) cutting the 0°-tape into sheeting sections;
(2) alternatingly distributing the sheeting sections among the at least two joining devices (C₁; C₂; . . . Cₙ);
(3) cohesively joining the sheeting sections to afford x°-tapes,
   wherein the handling device (B) rotates the sheeting sections in the new or unchanged advancement direction in such a way that after the rotation the regions which in the 0°-tape were disposed within said tape are now disposed parallel to the running direction of the respective x°-tape while the sides which in the 0°-tape were regions of the mutually parallel outsides are now aligned at the magnitude of the angle x to the running direction of the respective x°-tape.

As previously indicated it is thus to be ensured that the handling device (B) rotates the sheeting sections in the new or unchanged advancement direction by the magnitude of the angle x in such a way that after the rotation by the angle x the regions which in the 0°-tape were disposed within said tape are now disposed parallel to the running direction of the respective x°-tape while the sides which in the 0°-tape were regions of the mutually parallel outsides are now aligned at the magnitude of the angle x to the running direction of the respective x°-tape.

It is preferable when the process according to the invention is performed on the apparatus according to the invention.

The process makes it possible to accelerate the production of x°-tapes from elements cut and supplied from the supply sheeting compared to processes where the handling device (B) supplies only one joining device (C). This is made possible in particular by process step (2).

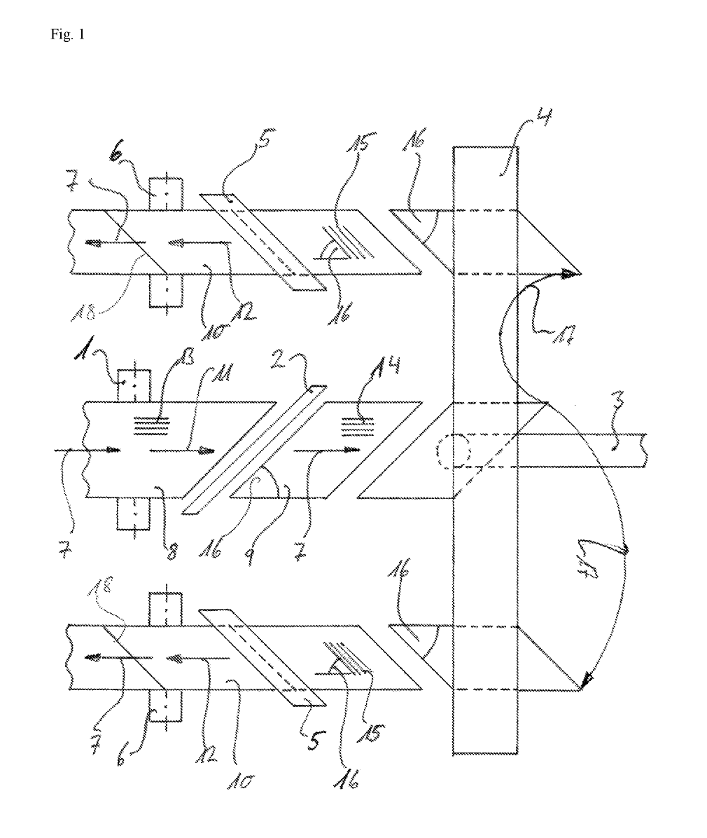

FIG. 1 shows a simplified form of the apparatus according to the invention in the E arrangement without any intention to limit the invention.

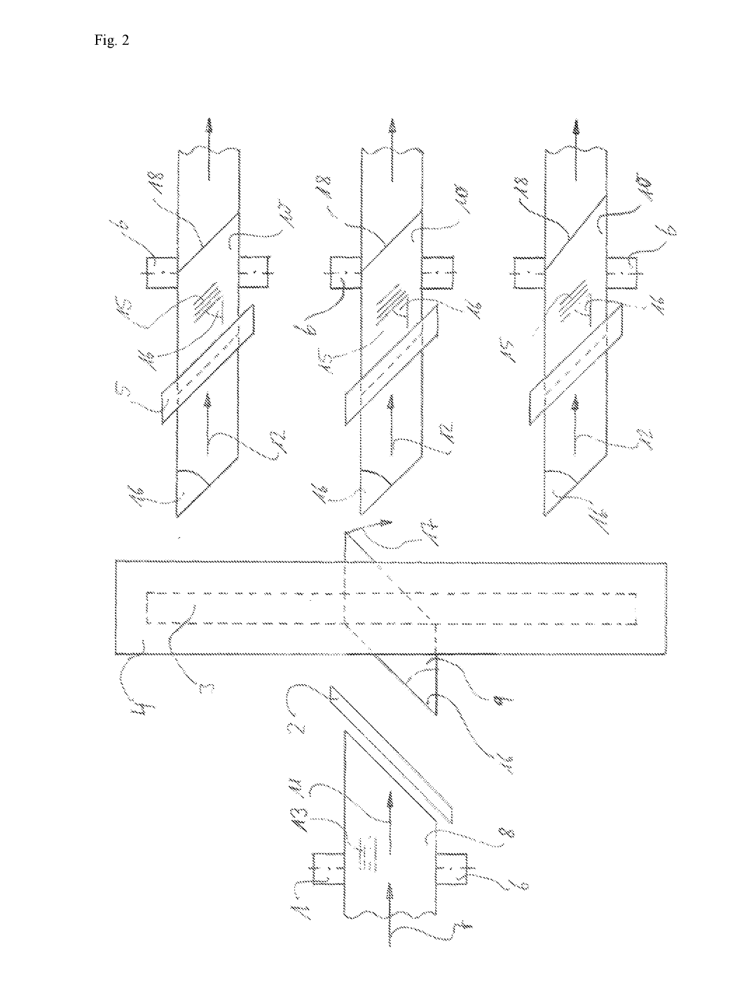

FIG. 2 shows a simplified form of the apparatus according to the invention in the Psi arrangement without any intention to limit the invention.

The reference numerals have the following meanings:
1 feeding device (F)
2 cutting device (A)
3 handling device (B)
4 crossbeam (K)
5 joining devices (C)
6 take-off devices (G)
7 advancement direction
8 0°-tape
9 sheeting section
10 x°-tape
11 running direction of the 0°-tape
12 running direction of the x°-tape
13 alignment of the fibres in the 0°-tape
14 alignment of the fibres in the sheeting section
15 alignment of the fibres in the x°-tape
16 angle x
17 direction(s) in which a sheeting section is rotated by the handling device
18 joining seam

1. An apparatus for semicontinuous production of an x°-tape, which is a semifinished sheeting constructed from unidirectionally endless-fibre-reinforced sheeting sections, wherein the fibres in this semifinished sheeting are aligned at an angle x having a magnitude from non-0° to 90° inclusive to the running direction of the x°-tape, comprising the following main components:
(A) a cutting device;
(B) a handling device;
(C₁; C₂; . . . Cₙ) at least two joining devices,
wherein the cutting device (A) is arranged upstream of the handling device (B), the handling device is arranged upstream of the at least two joining devices (C₁; C₂; . . . Cₙ) and the at least two joining devices are arranged in parallel with one another.

2. The apparatus according to claim 1, wherein the cutting device (A) has a feeding device (F), a first storage unit (E) and an unwinding device (D) arranged upstream of it and the at least two joining devices (C₁; C₂; . . . Cₙ) each have a take-off device (G), a second storage unit (H) and a winding-up device (J) arranged downstream of them.

3. The apparatus according to claim 1, wherein the apparatus comprises precisely two or precisely three joining devices (C).

4. The apparatus according to claim 3, wherein, in the advancement direction, the sequence D-E-F-A-B-C₁ (/C₂)-G₁ (/G₂)-H₁(/H₂)-J₁ (/J₂) or D-E-F-A-B-C₁ (/C₂ /C₃)-G₁ (/G₂/G₃)-H₁ (/H₂/H₃)-J₁(/J₂/J₃) results.

5. The apparatus according to claim 1, wherein the handling device (B) is suitable for laying the sheeting sections cut from a 0°-tape one behind the other in the same plane in such a way that in the sheeting sections the sides which in the 0°-tape were regions of the mutually parallel outsides are disposed opposite one another.

6. The apparatus according to claim 5, wherein the handling device (B) is configured as at least one of a robot gripping arm or gripping hand, a turntable and a rotatable suction device.

7. The apparatus according to claim 1, wherein the angle x has a magnitude of one of 30°, 33°, 45°, 60°, 75° and 90°.

8. A process for producing x°-tapes, which are semifinished sheetings constructed from unidirectionally endless-fibre-reinforced sheeting sections, wherein the fibres in these semifinished sheetings are aligned at an angle x having a magnitude from non-0° to 90° inclusive to the running direction of the respective x°-tape, comprising the following process steps:
(1) cutting the 0°-tape into sheeting sections;
(2) alternatingly distributing the sheeting sections among the at least two joining devices (C₁; C₂; . . . Cₙ);
(3) cohesively joining the sheeting sections to afford x°-tapes.

9. The process according to claim 8, wherein the handling device (B) rotates the sheeting sections in the new or unchanged advancement direction in such a way that after the rotation the regions which in the 0°-tape were disposed within said tape are now disposed parallel to the running direction of the respective x°-tape while the sides which in the 0°-tape were regions of the mutually parallel outsides are now aligned at the magnitude of the angle x to the running direction of the respective x°-tape.

10. The process according to claim 8, wherein before process step (1) process step
(0) feeding the 0°-tape
is performed and after process step (3) process step
(4) winding-up the x°-tape
is performed.

11. The process according to claim 1, wherein the process is performed on the apparatus according to claim 1.

12. The process of claim 8 further comprising utilizing the apparatus according to claim 1.
